(19) United States
(12) Patent Application Publication
(10) Pub. No.: US 2007/0288314 A1
(43) Pub. Date: Dec. 13, 2007

(54) Searching with Consideration of User Convenience

(75) Inventors: Yu Cao, Monterey Park, CA (US); Feng Lu, Monterey Park, CA (US); Kai Lu, Dong Chung (HK); Woodrow Cannon, Alpharetta, GA (US)

Correspondence Address: FISH & ASSOCIATES, PC;ROBERT D. FISH, 2603 Main Street, Suite 1050, Irvine, CA, 92614-6232, US

(73) Assignee: PLATFORMATION TECHNOLOGIES, LLC, Monterey Park, CA (US)

(21) Appl. No.: 11/754,081

(22) Filed: May 25, 2007

Related U.S. Application Data
(62) Division of application No. 11/694,930, filed on Mar. 30, 2007.
(60) Provisional application No. 60/800,131, filed on May 11, 2006.
(60) Provisional application No. 60/811,989, filed on Jun. 7, 2006.

(51) Int. Cl. G06Q 30/00

(52) U.S. Cl. 705/14

(57) ABSTRACT

A system that enables the search for providers of services or products, for a given user query that's in free text, and typically the services or products are focused on a particular area, such as an industry, a sector, etc. The system thus enables a searcher to submit queries that are substantially similar to those asked to an expert in the area, and get back results that are helpful in their decision making in obtaining services or products. Thus the searcher's experience is substantially similar to that of consulting a human expert. The system employs methods in matching and placing advertisements in relation to user queries and the concepts contained in these queries. Still further, it employs other various methods to enhance the searcher's effectiveness in their decision making. Finally, the system searches for queries that are composes of at least two languages. The system further comprises a method to (a) turn a large number of records, typically web pages crawled from the entire Web, into hundreds or even thousands of logical partitions, where each partition is associated with an identifier; and (b) take a user query that typically contains an identifier or several identifiers, and match records in those partitions with the identifier(s), or alternatively, take a user query, return multiple results, and then take the user's selection of identifier(s) and re-process the results so that only those associated with the selected identifier(s) are returned to the user.

This application claims priority to U.S. provisional application Ser. No. 60/800131 filed May 11, 2006 and 60/811989 filed Jun. 7, 2006 both of which are incorporated herein by reference in their entirety.

### FIELD OF THE INVENTION

The field of the invention is searching technologies.

### BACKGROUND

Searchers are getting more sophisticated with using search engines and other informational tools on the Web. It is true that “everyone googles”, but it is also true that no one types his itinerary to Google's™ search box and expects to get back a list of flights and prices—he knows Expedia does that kind of work and Google does not. On the other hand, if the searcher knows the name of a company and wants to find out its web site, as in searching for “American Airlines” and expecting to get its web address (happens to be www.AA.com), Google, along with other general web search engines, serves well this particular search need.

The distinctions between the use of Google and that of Expedia teach the following essential characteristics of an online information tool: (1) each has a different database. With a general web search engine, the database is web pages from the entire Web, and for Expedia, which we call an intermediary engine, the database is a product catalogue focused on flights, hotel and car rentals; (2) each takes in different kinds of user input. For general web search engine, it is free-text query, typically of a few words; and for intermediary engines, it is a form of multiple fields, each of which is to be filled by the searcher; (3) each has its own matching mechanism. For general web search engine, it is essentially exact matching between query words and words in web pages, with the preferred embodiment of proximity search. For intermediary engines, it is exact matching between values of fields in user input and those of fields in the database of a product catalogue.

Each tool serves different search needs of a searcher. When a searcher can formulate his search need in a few words, and want to find web pages contain exactly these words, general web search engines serve well. When a searcher can formulate his search need in a few pairs of attribute and value, and an intermediary engine contains catalogues of exactly the kind of products the searcher is looking for, then the engine will serve well.

All other information tools can be modeled with above-mentioned three characteristics. We enumerate below. (1) Home values, such as Zillow.com. A typical input is an address, or a street; expected results are home values; the engine's database is a catalogue of values of home at different addresses; (2) Bulletin board such as eBay.com. A typical input is keywords; expected results are items for sale; and the engine's database is forms filled out by sellers; (3) Business directories, such as Business.com. A typical input is keywords; expected results are company information; the engine's database is forms filled out by companies; (4) B2B search engines, such as Alibaba.com and GlobalSpec.com. A typical input is either keywords, or filled out forms; expected results are product specifications and their manufacturers; the engine's data is product catalogues of certain classes of products; (5) Comparison shopping sites, such as NexTag.com, which is similar to Expedia in terms of input, results and database; (6) local search engines, such as CitySearch.com, and Google's local.google.com, which is yet another variation of intermediary engines. A typical input are of two fields, one for the name of a business, or the category of a business, as in “Chinese restaurants”, and the other field for a location, as in a city or a zip code; the expected results are a list of businesses, their contact information, and some times a short description of their services; and the engine's database is essentially yellow pages information.

The currently available online information tools, while each serves well for the purpose it is built, leave a large white space of un-served search needs. Consider, for example, the situation of a searcher in the area of real estate. She is hunting for an apartment or a house, for a temporary relocation of 12 months. If she wants to use a corporate housing company, then querying “Oakwood corporate housing” or such on Google might well satisfy her search need. If, however, she wants to rent from other parties, and knows the city well enough, searching through Apartments.com's catalogue might suffice. However, if she poses her search need as a natural language query, such as “family of two kids, one dog, looking for an apartment or a house, close to West Los Angeles, with good schools, one year lease”, then no available online tools can return helpful results to her.

For a searcher who is interested in finding information in an area, such as an industry or a specific sector of an industry, a general web search engine is wanting. Among other things, the search engine would typically search against a set of all the web pages that it can crawl from the entire Internet, and these pages number close to 10 billion as of this writing. That is an enormous number given that there are probably less than 10 million relevant pages. This phenomenon in turn leads to the observed situation where returned results for a given query include records that are entirely or largely irrelevant to the area of the searcher's interest.

One way of improving the situation is for the web search engine to partition its database into hundreds or even thousands of areas. The searcher is asked to pick one or more areas when conducting a search, and the engine searches for results only from the area or areas picked by the searcher.

### SUMMARY OF THE INVENTION

This application pulls together several different concepts, each of which is but a part of the inventive subject matter. Among other things, that subject matter provides systems and methods in which an online information tool has one or more of the following characteristics: (1) taking in user queries that are free text, just like queries to web search engine's, but segments a query into one or more pieces of information, not unlike a filled out form used by intermediary engines; and (2) applying knowledge from the given area, to each of the above.

The system thus enables the searcher to submit queries that are substantially similar to those asked to an expert in the area, and gets back results that are helpful in their decision making.

We employ the following methods in automatically creating a parameterized database from records such as web pages, with a focus on a given area, such as an industry, a sector:
With “embedding browsing of an information space in multiple-cycled search”, the system employs methods that provide suggestions to a searcher in modifying his query for further searches. The dataset being searched can be characterized as having multiple identifiable portions. Suggestions are created so that they are relevant to the searchers' query or series of queries, and typically they are derived from knowledge of an area which could be an industry, a sector. There are two types of suggestions. The first type helps to narrow down a search, thus returned results are expected to be more specific, typically from a same portion of the dataset. The second type helps to broaden a search, thus returned results are expected to be from different portions of a dataset. When some of the suggestions are used by the searcher, the series of searches are reminiscent of a browsing behavior embedded in the multi-cycled search.
With “automated calculation of summary”, the system employs methods that select fields of a record of an entity, such as a company, that best facilitate the searcher's need in decision making regarding the entity. Additional fields might be select dependent on the user query.
With “automated calculation of reputation”, the system employs methods of automated calculation of a company's finesse in providing services in an area which could be an industry, a sector. Further, a finesse measure is calculated for each of significant factors within the area. For example, for the industry of logistics and transportation, such factors include a geographical area, a route between two or more places, a narrowly focused service.
With “combing static and dynamic snippets”, the system employs methods in calculating a snippet as part of search result, by combining a static portion, which has been calculated before serving user query, and a dynamic portion which is calculated on-the-fly based on a user query.
With “integrating Request for Quotes (RFQs) in search”, the system employs methods that for a given user query, select the most appropriate Request for Quote (RFQ) from a number of candidate RFQs, and determine which fields of the RFQ to display dependent on the user query, and further create-on-the-fly additional fields based on the user query.

We employ the following methods to match the best advertisers to a searcher's search need:
With “matching advertisements based on concepts”, the system employs methods that allow advertisements and user queries be matched based on concepts in addition to words and phrases. Concepts are typically focused on an area such as an industry, a sector.
With “integrating rich content advertisements into search”, the system employs methods that determine for a given user query, the best matching rich content items (preferred embodiment being advertisements) from a company, as well as the most appropriate language in which a rich content item is voiced over when there is an audio component, or in which a rich content item is subtitled if there is a caption component.
With “placement and display of advertisements in zones”, the system employs methods that place advertisements into different zones on search results display pages. A zone determines the prominence of the display of an advertisement. The placement of an advertisement is determined by a number of factors, such as the extent of matching between the advertisement with a user query, the monetary amount the advertiser has agreed upon, the exclusivity arrangement, as well as possible conflict with other advertisements.

We employ the following methods in maximally taking advantage of human factors at user interface:
With “user interface that facilitates display of voluminous contents”, the system employs methods that facilitate the re-use of areas of a web page. With one method, a toggle enables switching the display of one content and that of another in one area. With another method, a web page is divided into two areas. Two buttons are placed in one area. By clicking the first button, the area is shrunk into a thin bar, and the other area of the web page expands to fullest possible size. The bar contains the second button, by clicking which the two areas are restored to their original sizes.

We provide convenience tools that are an interrogated part of search results, with following methods:
With “convenience tools integrated with search”, the system employs methods that create a number of convenience tools for a given area, an area could be an industry, a sector. The system also employs methods that place the most relevant convenience tools most prominently, in relation to the user query, the return results, other contents on the results page, and information about the searcher.

We allow users to place banner ads, company logos, or other images in order to facilitate the searcher's navigation to his frequented online destinations, as well as placing buttons to reach favorite tools, via following methods:
With “efficiency panel for navigation and convenience”, the system employs methods that help a user create an “efficiency panel” that includes buttons and logos that improve the user's efficiency in online activities, in using convenience tools and other daily activities. The efficiency panel is part of the personalized home page of a web site, the preferred embodiment being the home page of our engine. In the panel, the user can place a number of images, each of which is associated with a destination on the Web. These images are selected from a pool of candidates, and placed so that the convenience of a user is maximized. The measure of convenience is calculated mainly based on the user's observed frequent destinations on the Web. The user can put buttons on the efficiency panel, and each button is used in reaching a tool from a list of convenience tools offered by our system, or by others. The convenience tools include measurement unit converter, tariffs search, scratch pad, etc.

We provide a language- and region-specific informational experience to a user, via following methods:
With “searching with mixed language”, a user query can comprises of at least two languages.

Various aspects of the inventive subject matter can also be perceived as objects and advantages, each of which can be implemented independently of the others, and each of which should be viewed as desirable but not essential.
In one aspect, one can employ means such as automatically generated company summaries, query-dependent Request for Quotes, and others, to facilitate a searcher's need of deciding on which service providers to contact and how.
In another aspect, one can match and place advertisements, including rich content advertisements, taking advantage of the above mentioned methods, so that better matching between search need and advertiser's needs is achieved than what is available with the state-of-the-art online advertising.
In another aspect, one can provide searchers with a number of ways in improving their efficiency in their daily activities, such as getting to frequented online destinations, as well as reaching for tools that improve their productivity.

Viewed from yet another angle, one set of inventions addresses industry knowledge.
An industry expert would base recommendations upon extensive industry knowledge; what companies offer what services, which ones are the most reputable, cost-effective, reliable, and so forth. This all accomplished by the current inventions.

Another set of inventions improve searching functionality:
A searching expert would guide buyers of goods and services past all the irrelevant information, and focus in on the features that distinguish one vendor from the next. Where the buyer is not aware of a particular feature or parameter of interest, the expert would ask relevant questions. This is precisely what is being automated.
The system can guide users to provide information that distinguishes suitability of vendors from one another
The system can guide users to consider related products and services that they may have ignored.
Parameterization and normalization of data allows all data to be searched in multiple languages. Currently, web pages can be searched only in the language shown on the page.
Completely independently of the other inventions, searching is greatly facilitated by associating individual web pages with SIC or other industry codes. This provides much greater granularity than existing industry filters, while still covering substantially all goods and services.

Another set of inventions increase the value of click-throughs to advertisers:
An industry expert would provide additional value by guiding buyers towards appropriate sellers. On the Internet this is done through advertising. Unfortunately, an enormous amount of advertising is wasted because the focus is on simplistic keyword matching, and because the current trend of open-auction bidding precludes an advertiser from properly scheduling his advertising. All of these problems are resolved by the current invention.
Charges can be based on logical abstractions rather than verbatim text
Advertising can be scheduled for future placement, such as near product announcements
Advertisers can purchase guaranteed “on top” positioning.
Advertisers can purchase positioning for fixed periods of time.
Advertisers can be grouped according to sales channel to exclude competing advertisers.

Our inventions can turn a web search engine into a “specialized search engine in multiple areas”, by a way of partitioning its dataset. Such partitions can advantageously be along industry lines, or even along the lines of sectors within industries.

In a preferred set of embodiments, a “B2B search engine in multiple industries” allows a user to choose an industry from a list of industries, and submit a query. The engine returns results about the chosen industry.

In order to have this search capability, the web search engine could map all the available web page URLs to SIC or other industry codes. That mapping might be stored in a “name-code-url” or “name-code-domain” table. Once the mapping has exhausted all web pages in the dataset, which at the state of the art of 2006, is about 4-8 billion pages, such tables would most likely have only millions as opposed to billions of entries.

The reduced dataset could then be partitioned into multiple industries. At this step, a many-to-one “code-to-industry” table could be created, possibly manually. That table might have only hundreds or thousands of industries. The partitioning software program would then iterate though the “name-code-url” table, and perform the following: (a) for each entry, look up its code in the “code-to-industry” table; and (b) copy the web page of the “url” to a hard-disk location where all web pages belonging to the “industry” are stored.

Once this program has exhausted the “name-code-url” table, there would be multiple datasets corresponding to the different industries. In this way the initial dataset has been partitioned according to industry.

Serving user queries.

In one embodiment, the user is asked to provide both (a) a user query, just like he would to a current web search engine; (b) a selection of one or more industries from a displayed list of industries. The engine will apply the current search technology only to the (partitioned) datasets for the selected industries, and return ranked web pages;

In another embodiment, the user is asked to provide only a user query, just like he would to a current web search engine. The engine returns results, the user can select one or more industries from a list of industries, and the engine can perform a re-processing of the results. The re-processing is done so that only those results from the industry or industries selected by the user will be kept and displayed to the user.

### ADDITIONAL DESCRIPTION OF PARTICULAR ASPECTS

1. Embedding Browsing of an Information Space in Multiple-Cycled Search

Our engine in general assumes that a search is multi-cycled, namely more than one query is submitted by the searcher in order to satisfy one search need. A multi-cycled search “session” goes as follows: a searcher starts with a need to satisfy, formulates a query, submits to our engine, and gets returned results. If the searcher's need is satisfied, he's done. However, it is very likely that he needs to submit one or more additional queries. Many times he modifies a previous query in obtaining a new one.

During such a multi-cycled search session, our engine provides suggestions to the searcher on how to formulate a new query. The suggestions take the form of clickable links.

The dataset being searched typically has multiple identifiable portions.

The suggestions can either help the user to explore deeper into a same portion of the dataset, by adding more restrictions to his previous search, or help him to explore more broadly, namely reaching different portions of the dataset, by starting a query that is completely different in wording but related to a previous query.

When the user follows some of these suggestions, his entire session of search exhibits a “browsing” nature. (“Browsing” is a familiar behavior with a directory of information. A user click on links and in the process goes up and down on a hierarchy of information items such as web pages.) The searcher in our case gets a chance to be led to different parts of the information space that's defined by our dataset.

One added benefit is that more parts of our information space are exposed than otherwise. A searcher is unlikely to come up on his own all possible queries that will retrieve all the information he's looking for, due to issues such as mismatching vocabulary (e.g. the searcher has “UCLA” in the query while search engine's data contains “University of California at Los Angeles”).

This benefit of exposing more of the dataset is not available to the current web search engines which typically does not have suggestions that aide the searcher, and even when there are (in the case of Ask.com, as described in Possible Prior Art), the exposure is not necessary effective in our opinion.

2. User Interface that Facilitates Display of Voluminous Contents

Since a company typically has a lot of information that might be of interest when a searcher is making a business decision, it is important to provide an intuitive, simple interface so that the presentation of the information is not cluttered.

(1) Toggle between Chinese and English text

When a company has both Chinese and English text, on the user interface there is a button for toggling between Chinese and English.

(2) “Shrink-and-Restore” an Area on a Web Page

We have developed the “shrink-and-restore” feature on the user interface, so that with a click on a button, a portion of a web page can shrink into a sliver of bar, and with a click on the said bar, the portion is restored to its original size.

It gives the viewer control over how much real estate on the web page she wants to allocate to things she wants to study.

3. Automated Calculation of Summary

One class of embodiments in our system creates a summary for each company. When a user clicks on a search result, which could be focused on a company, the search result leads to the Summary page rather than directly to the web site of the company as web search engines currently do.

On the page displaying a company's summary, the left column displays the summary information our system has created by synthesizing different sources; and the right column is the web site of the company.

With the Summary, the user can get a quick overview of the company, and decide whether the company is a fitting provider. If the user still cannot make the decision, he can explore the company's web site.

To automatically create a company's summary, the engine picks a number of pieces of information that has been obtained in the set of creating a parameterized database from web records.

These pieces of information from the parameterized record for an entity, in this case, a company, include. The selection is made so that the summary is expected to best facilitate the searcher's decision on whether to use the company's services:

1) An introductory text about the company. Currently our engine simply takes the Meta Description of the company's web site. This could be replaced by more sophisticated way of extracting a company's motto, tag line, mission statement, overview, or some such.

2) The main services provided by the company

3) Major service regions

4) Contact information, contact persons

5) Any of the information above could be translated into one or more languages

Further, additional pieces of information might be included in the summary dependent on the user query.

Automated Calculation of the Most Useful Pages of a Company

We calculate the ‘most useful’ pages of a company, and include a small number (currently two) of them in Company Summary of the company. Typically such a page contains much service description, or contains useful contact information, or otherwise information “useful” to a searcher in making his/her decision.

During the Extraction step, our engine assigns a usefulness score of a page based on the recognized services, contact information, or other types of information that are deemed as ‘useful’.

4. Automated Calculation of Reputation

Our system assigns a “reputation” measure to each company. Factors are

1) Size of the company (employee number, revenue, offices around the world, etc.)

2) Industry awards

3) Listing in important directories (e.g., the directory maintained by the Port of Oakland, or directories maintained by magazines)

4) Mentioned by magazine articles

5) Having a relationship with other reputable companies (e.g., agents for airlines, etc.)

6) Having reputable companies as clients

7) Being an advertiser with print or online media

8) Feedback from our search engine users

9) Our in-house experts' opinions

10) Others

The Company Reputation helps in ranking otherwise equally fitting providers.

A company could be a big player in nationwide services, but does not have service in a particular city. Similarly, a company could be a big player in a particular city or state but does not provide any service beyond its service regions.

Distributed Reputation calculates a company's reputation by criteria such as a given region (country, state, city), or a route, or a particular segment of the industry (public warehousing, private warehousing), or on any other factors that's meaningful within the industry context.

Distributed Reputation is then applied in ranking results.

5. Combing Static and Dynamic Snippets

Snippets give a “window” through which to see some of a company's services and other information related to a query. It is the first thing a searcher sees about a company (the other is the Company Summary with our engine), and the quality of snippets has a large impact on whether a searcher is helped or hurting in making a right pick.

Since Google, web search engines use “dynamic” snippets that are calculated on-the-fly for a given query. Before Google, some engines used “static” snippets, which is independent of query.

Our snippets calculation combines static and dynamic snippets. Some of a company's salient information is independent of query, and could help in searcher's picking the company; and other information of the said company is dependent on query, and shall be calculated on-the-fly for a given query.

6. Search with Multiple Languages

Over the last decades, English has emerged as the language of commerce, and Chinese has established as the other language to be reckoned with in commerce. However, there has not been a search engine that is devoted to severing this international market. Namely Google™Yahoo™/MSN™ do English search, and Baidu™ does Chinese search only. All engines do exact matching. The current situation is that a user searches on Google with a Chinese query might get back pages that are in mixed Chinese and English, and the advertisements are sometimes not in Chinese, which reduces the usefulness of the search results, as well as the effectiveness of the ads. Baidu does the same thing in a mirror image.

Our system performs search with awareness of language and region. It does at least the following:

1) filtering ads based on user query's language, (considering a company that has multiple ads)
a) if a user query is entirely in Chinese, serve ads dubbed in Chinese
b) if a user query is entirely in Chinese, server ads specifically targeting the Chinese audience
c) do (a) and (b) for other languages
d) Take into consideration the region of the user, namely the geographic location where the user has submitted the query. When this information is available, serve ads specifically targeted to the region.

2) serving web page contents based on user query's language
a) On our engine's homepage, its results pages, etc., a web page is divided into multiple areas, and each area's content could be dependent on a user's language and/or region.
b) The implementation could be in ajax or similar techniques

3) Normalize into meta information
a) Normalize queries into (internal) meta information
b) Identify and normalize records in our system's dataset. For each entity, there are two provisions: (a) if there is information for the entity is language- and region-specific, then it is matched with higher priority with the user query's language and region; (b) the system prepares translation for certain part of an entity's record, and the translated information is matched against the user query's language and region.

4) When a searcher is led by our system to a destination web site, pass the language ID, the region, and other similar information to the web site
a) General web search engines do not do this right now;
b) Some affiliate network web sites pass their own ID to a destination web site such as Amazon.com, but it does not appear that they pass language IDs or regions;
c) Our system will pass this information to a destination web site, and the web site can make sure of this information in serving its contents, much like how our system serves ads and contents with awareness of a user's language and region.

Other aspects of the inventive subject matter that are not being prosecuted at the outset include the following:
A method of facilitating a search by a user, comprising providing a display to the user that includes a button that when clicked triggers at least one of the following: (a) alters relative sizes of zones within a display; (b) leads to either a home page of a web site for company, or a page expected to be especially useful, and the button includes a logo of a company; and/or (c) a convenience tool (e.g., measurement units converter, tariffs search, scrap pad).
A method of charging for a Web advertisement, comprising: (a) establishing a charge according to a logical abstraction (concept) derived from a search term (e.g. user enters circumstance that requires rail service, and system shows an advertiser related to “rail service”); (b) charging an advertiser according to a charge per click established in a blind auction; (c) allowing advertisers to bid for future placement (e.g. Sunday nights during coming month); (d) charging an advertiser according to a fixed price for a period of time (similar to a newspaper ad); (e) characterizing advertisers into groups according to a market-related parameter (e.g. sales channel (retail, on-line, and manufacturers)), and including in the display first and second zones, each of which excludes more than one advertiser from any given one of the groups; (f) the advertisers within a given group being mis-sorted with respect to charge per click; (g) charging an advertiser for exclusive placement within a zone; and/or (h) charging an advertiser for “on top” placement within a zone.
A method of facilitating a search, comprising: creating a summary of a given company's services, by including fields from the parameterized records of a company that are deemed to be important; identifying in a web site pages deemed to be important; and providing links to those particular pages.
A method of facilitating a search, comprising: receiving a search term from a user; applying the search term against the records produce a results set, and provide at least a portion of the results set to the user in a display; applying a rule to determine circumstance information to be obtained from the user, and provide guidance to the user related to the circumstance information; narrowing guidance (additional information needed to narrow search, e.g. perishable) broadening guidance (related companies and services); and providing an advertiser's moving image or other rich content items as part of a display of a search result. That concept can further include: (a) applying a rule, typically derived from knowledge of the industry, to the results set, to eliminate a member of the results set; (b) ranking members of the results set according to a reputation measure for a company, such a measure having been calculated before the search take place; and ranking member of the results set according to a second reputation measure for a company, when the use of the measure is considered the most appropriate in response to user's query; (c) calculating and displaying snippets for each member in the results set. At least one word in a snippet is independent of the user query, and at least one word in a snippet is dependent on the user query.
A method of facilitating a search, comprising: annotating an advertiser's advertisement with text, including words, phrases, concepts; annotating an advertiser's advertisement with language, region that the advertisement targets; normalizing annotations into meta information; matching the advertisements from an advertiser with a given user query, and include one or more best matching advertisements in the search result; discerning the language of a user query; discerning the region from which the user query has been submitted; displaying, when possible, those advertisements that are in the same language as that of the user query; and displaying, when possible, those advertisements that are of the same region as that of the user query. That concept can further include: (a) displaying the company summary of a search result if it is a company; and displaying more fields from the company's record based on the use query; (b) providing a Request For Quote (RFQ) page for companies selected by the user; displaying at least one field of the RFQ that has been determined prior to the search; and displaying at least one field of the RFQ that is determined based on the user query; and/or (c) displaying convenience tools most relevant to the user query.
A method of facilitating a search of a plurality of records, comprising: identifying company names in individual ones of the plurality of records; correlating the company names with industry identification codes; and correlating the industry identification codes with the corresponding individual ones of the plurality of records. Within that concept, the plurality of records can: (a) comprise Internet web pages; (b) comprise information from Internet web pages; (c) number more than one hundred million; and/or (d) number more than one billion. Also, the industry identification codes can: (a) comprise Standard Industry Codes (SIC codes); (b) be derived from Standard Industry Codes (SIC codes); and/or (c) comprise or are derived from the group consists of the North America Industry Classification System (NAICS) and The United Nations Standard Products and Services Code® (UNSPSC®). The inventive concept can further comprise: (a) correlating a first one of the industry identification codes with additional of ones the plurality of records based upon similarity of domain names within the records; (b) providing an interface through which a user can enter an industry identifier, and using at least one of the industry identifier and information derived from the industry identifier to narrow a search. Additionally or alternatively, the industry identifier can comprise: (a) at least one of the industry identification codes; and/or ( b) a search term, and the information derived from the industry identifier comprises at least one of the industry identification codes. The inventive concept can also include the step of using at least one of the industry identifier and information derived from the industry identifier to narrow the search comprises interpreting a search string according to Boolean logic; and/or (b) providing a first interface through which a user can enter a search term, providing software that filters the plurality of records according to the search term to produce a subset, and providing a second interface through which the user can enter an industry identifier that can be used to further filter the subset.

Thus, specific embodiments and applications of searching and billing improvements have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1-10. (canceled)

11. A method of charging for a Web advertisement, comprising allowing advertisers to bid for future placement.

12. A method of charging for a Web advertisement, comprising charging an advertiser according to a fixed price for a period of time.

13. A method of charging for a Web advertisement, comprising characterizing advertisers into groups according to a market-related parameter, and including in the display first and second zones, each of which excludes more than one advertiser from any given one of the groups.

14. A method of charging for a Web advertisement, comprising charging an advertiser for exclusive placement within a zone.

15. The method of claim 14, wherein the exclusive placement comprises “on top” placement.
